(19) United States
(12) Patent Application Publication
(10) Pub. No.: US 2001/0030486 A1
(43) Pub. Date: Oct. 18, 2001

(54) Electric machine with structural spacer

(76) Inventor: Joseph M. Pijanowski, Clarendon Hills, IL (US)

Correspondence Address: Keith A. Vogt, Niro, Scavone, Haller & Niro, Suite 4600, 181 W. Madison, Chicago, IL, 60602, US

(21) Appl. No.: 09/757,928

(22) Filed: Jan. 10, 2001

Related U.S. Application Data
(63) Continuation-in-part of application No. 09/519,798, filed on Mar. 6, 2000.

(51) Int. Cl. H02K 1/12

(52) U.S. Cl. 310/254; 310/67 R

(57) ABSTRACT

An improved slotted stator electric machine for use in various rotary and linear applications. The machine is significantly quieter in operation, is resistant to corrosion, and operates at increased electrical and magnetic efficiency with augmented performance without adding significantly to its weight and cost. The machine uses non-magnetic, and high compressive strength spacers which are installed between the stator teeth to create or facilitate a compressive force in an inner ring comprised of the spacers and the inner portion of the teeth. Through the interaction of the teeth pieces, this creates or facilitates an opposing tension in the outer ring of the stator which strengthens and stabilizes the stator assembly. A ceramic/porcelain enamel material or other bonding agent can also be used to coat, bond together, increase the compressive strength and to further stabilize and secure the stator and/or rotor laminations while providing corrosion resistance. The stator assembly and/or rotor assembly can be formed whole or in part from non-oriented grain electrical steel and/or advantageously, from low loss oriented grain electrical steel.

This application is a continuation-in-part of application Ser. No. 09/519,798, filed Mar. 6, 2000.

### BACKGROUND OF THE INVENTION

This invention relates to reducing the objectionable amount of acoustic noise produced by slotted stator electric machines while allowing for provisions of increased efficiency, and augmented performance.

Over the years a large amount of research has been done in order to reduce or eliminate the many objectionable operating characteristics associated with slotted stator electric machines. While the majority of problems have been successfully addressed, two problems remain a serious obstacle to further increases in efficiency and/or more widespread use. These problems are; the somewhat limited electrical efficiency (imposed by the inability to use low loss grain oriented electrical steel in many stator designs) and the objectionable amount of acoustic noise and vibrations produced by the stator deflections and/or oscillations (perpetuated by insufficient stator stiffness) of these machines. The intent of the present invention is to address the problems in a simple mechanical manner which does not add a significant amount of weight and cost to the machine which is the case with many conventional and current solutions.

### SUMMARY OF THE INVENTION

An improved slotted stator electric machine is provided for use in various rotary and linear applications. Advantageously, the improved slotted stator electric machine is significantly quieter in operation, is resistant to corrosion, and operates at increased electrical and magnetic efficiency with augmented performance without adding significantly to its weight and cost.

Significantly the preferred embodiment of the machine uses non-magnetic, and high compressive strength spacers which are installed in such a manner between the stator teeth to create or facilitate a compressive force in an inner ring comprised of the spacers and the inner portion of the teeth (closest to the rotor) which, through the interaction of the teeth pieces, creates or facilitates an opposing tension in the outer ring of the stator. The intent and purpose of the aforementioned construction and opposing forces of tension and compression is to significantly strengthen and stabilize the stator assembly which includes integral tooth pieces and to allow construction of a very stabile stator utilizing separate tooth pieces. A ceramic/porcelain enamel material or other bonding agent can also be used to coat, bond together, increase compressive strength and to further stabilize and secure the stator and/or rotor laminations while providing corrosion resistance. The stator assembly and/or rotor assembly can be formed whole or in part from non-oriented grain electrical steel and/or advantageously, from low loss oriented grain electrical steel. Said stator and/or rotor can have separate and/or integral tooth pieces.

### BRIEF DESCRIPTION OF THE DRAWINGS

The novel features which are characteristic of the present invention are set forth in the appended claims. However, the invention's preferred embodiments, together with further objects and attendant advantages, will be best understood by reference to the following detailed description taken in connection with the accompanying drawings in which:

FIG. 1 is a cross sectional front view of a slotted stator electric machine with separate stator tooth pieces in accordance with the principles of the present invention.

FIG. 2 is a cross sectional top view of a slotted stator electric machine with separate stator tooth pieces in accordance with the principles of the present invention.

FIG. 3 is a cross sectional side view of a slotted stator electric machine with separate stator tooth pieces in accordance with the principles of the present invention.

FIG. 4 is a cross sectional front view of a slotted stator lamination with integral tooth pieces in accordance with the principles of the present invention.

FIG. 4A is a cross sectional front view of a slotted stator lamination with separate tooth pieces, separate stator pieces and separate intermediate pieces in accordance with the principles of the present invention.

FIG. 5 is a cross sectional front view of a stator spacer made from two different materials in accordance with the principles of the present invention.

FIG. 6 is a cross sectional top view of a stator spacer made from two different materials in accordance with the principles of the present invention.

FIG. 7 is a cross sectional side view of a stator spacer made from two different materials in accordance with the principles of the present invention.

FIG. 6A is a cross sectional top view of a stator spacer made from three wedge shaped pieces in accordance with the principles of the present invention.

FIG. 8 is a cross sectional front view of a rotor lamination with separate tooth pieces in accordance with the principles of the present invention.

FIG. 9 is a cross sectional front view of a rotor with separate tooth pieces, rotor spacers, and a thin sleeve in accordance with the principles of the present invention.

FIG. 10 is a cross sectional front view of a slotted stator electric machine with 2 stator teeth and 2 faux teeth in accordance with the principles of the present invention.

FIG. 10A is a cross sectional front view of a slotted stator electric machine with 2 stator teeth in accordance with the principles of the present invention.

FIG. 10B is a cross sectional front view of a slotted stator electric machine with 4 stator teeth and cross shaped spacers in accordance with the principles of the present invention.

FIG. 11 is a cross sectional front view of a slotted stator electrical machine of the prior art.

FIG. 12 is a cross sectional front view of a slotted stator electrical machine with resilient mounted stator teeth in accordance with the principles of the present invention.

FIG. 13 is an enlarged partial cross sectional front view of a slotted stator electrical machine with resilient mounted stator teeth in accordance with the principles of the present invention.

### DETAILED DESCRIPTION OF THE PREFERRED EMBODIMENTS

Set forth below is a description of what are currently believed to be the preferred embodiments or best examples of the invention claimed. Future and present alternatives and modifications to the preferred embodiments are contemplated. Any alternates or modifications in which insubstantial changes in function, in purpose, in structure or in result are intended to be covered by the claims of this patent.

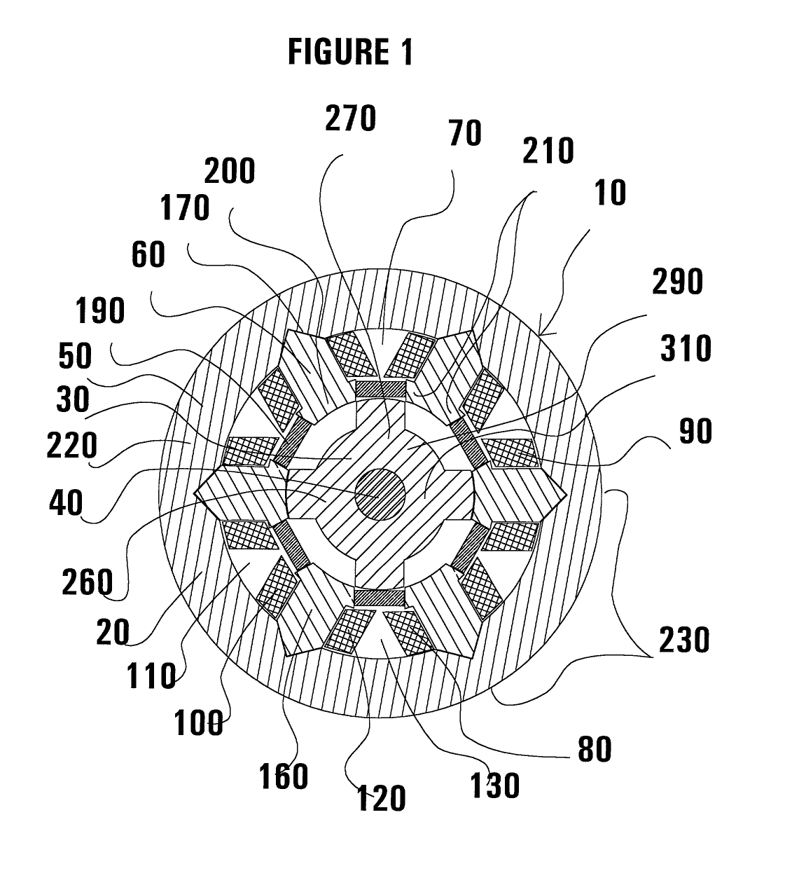

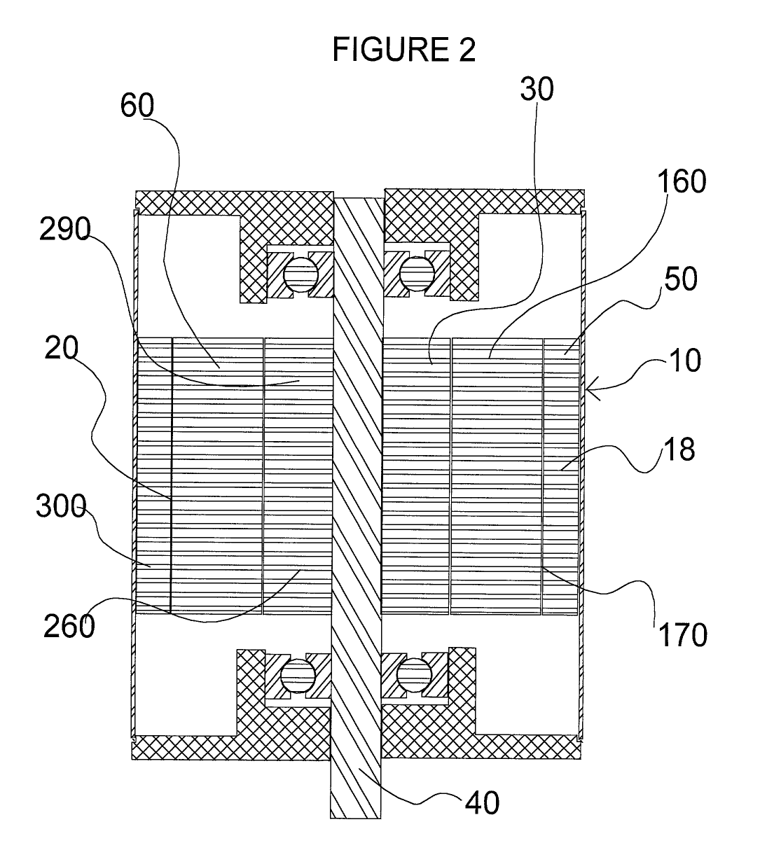

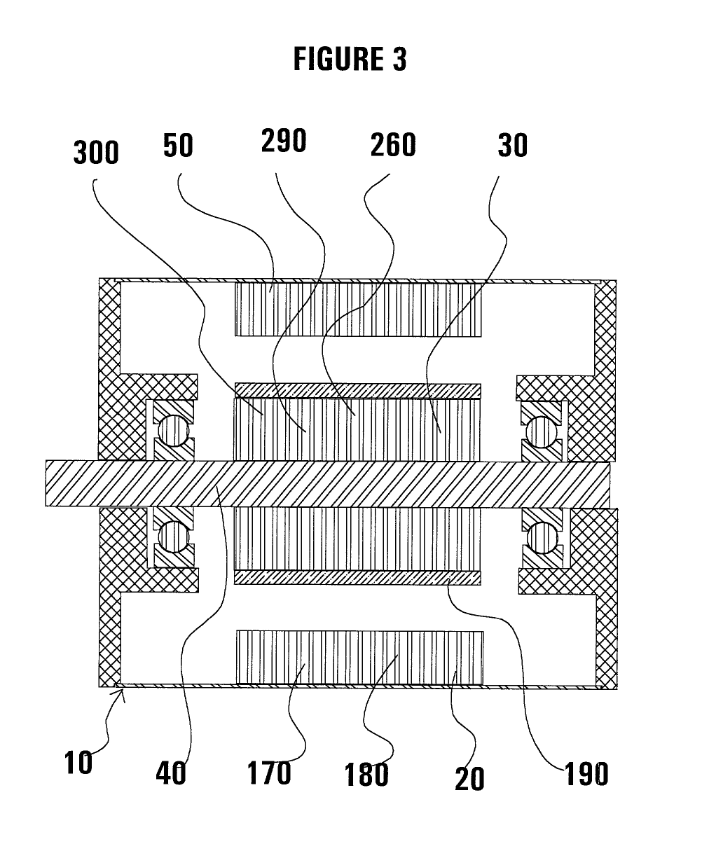

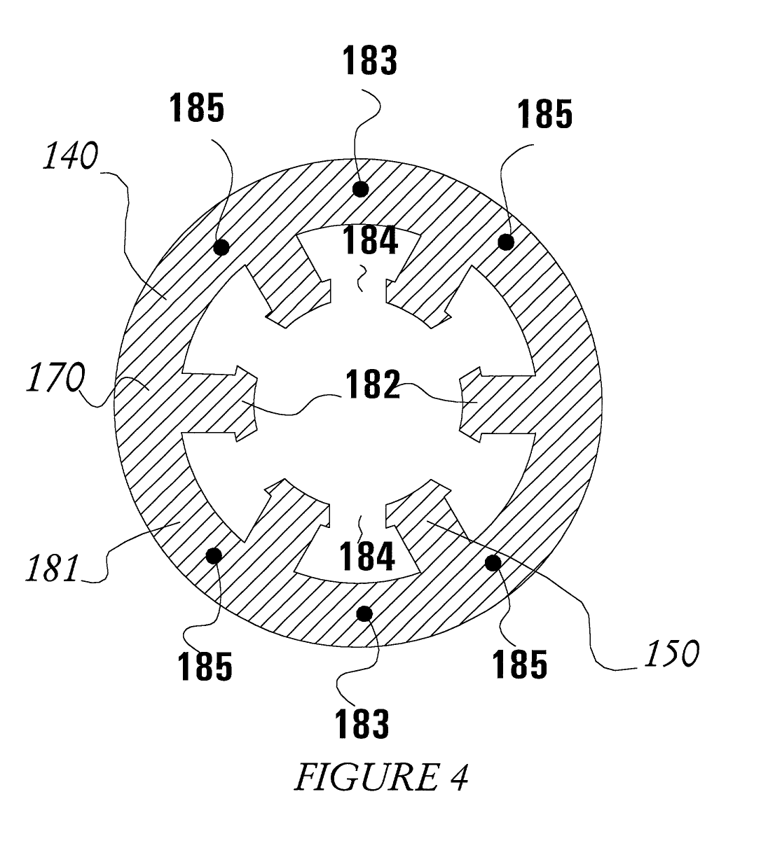

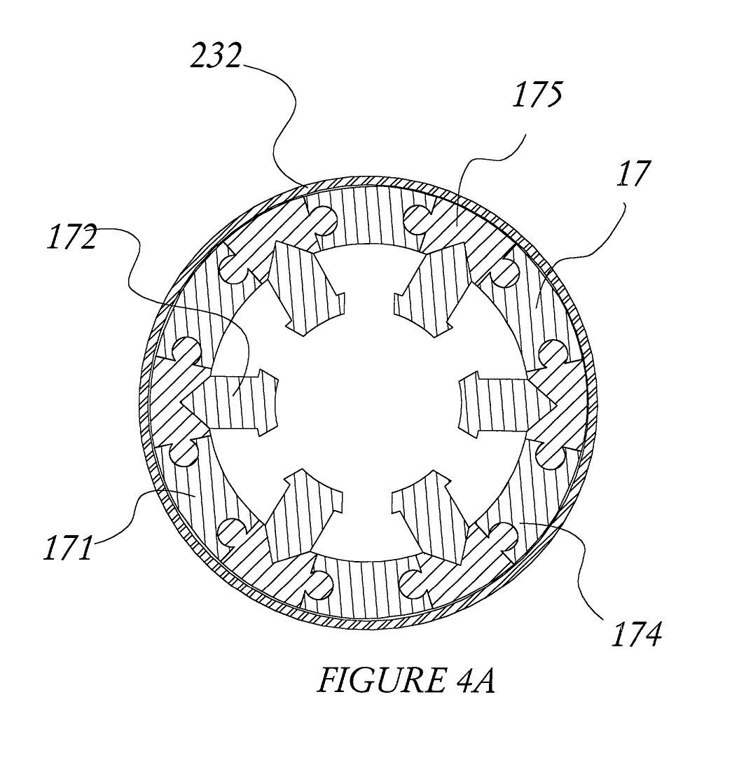

An improved slotted stator electric machine 10 (FIG. 1, 2, and 3) is provided for various applications. The machine having a stator assembly 20 and a rotor assembly 30 including a shaft 40 on which the rotor assembly is mounted for rotation relative to the stator assembly, the stator assembly including a stator 50 having a plurality of stator teeth 60 (FIG. 1 and 2) defining stator slots 70 (FIG. 1) there between with a plurality of concatenated stator winding sets 80 inserted in the stator slots, each set of stator windings including coils 90 which surround one or more of the stator teeth whereby one part of a coil 100 is inserted in one stator slot 110 and another part of the coil 120 is installed in another stator slot 130. The stator 140 (FIG. 4) can include integral tooth pieces 150 or separate tooth pieces 160 (FIG. 1 and 2). Advantageously the separate tooth pieces can have the windings installed on them before the teeth are installed into the stator assembly. This allows for efficient and compact installation of the windings resulting in a higher stator fill factor and a very securely fastened winding without the need for additional devices to secure the windings. The iron stator laminations 170 (FIG. 1, 2, 3 and 4 ) can be coated and bonded together with a ceramic/porcelain enamel material 180 (FIG. 2 and 3) or other bonding agent between the laminations to stabilize, strengthen, and secure the stator laminations and lamination assembly. The stator assembly can be formed of alternating layers of laminations 181 (FIG. 4) with integral tooth pieces 150, and, laminations 170 (FIG. 1) with separate tooth pieces 160. A dampened stator design is also made possible by using a construction such as alternating layers of spacer laminations 181 (FIG. 4) and conventional laminations 440 (FIG. 11) and including a resilient or preferably a viscous material between said lamination layers. Being that the resonant frequencies of the spacer laminations and the conventional laminations are significantly different and the fact that they are coupled viscously, any vibration induced by the operation of the machine would be effectively dampened. For higher efficiency, the stator laminations with separate tooth pieces can be formed of non-oriented grain electrical steel and/or advantageously, of low loss oriented grain electrical steel. The stator lamination which includes separate tooth pieces can be assembled from as many pieces and shapes of both oriented and non-oriented electrical steel as necessary to modify and improve the efficiency of the flux path therein. An example is cited in FIG. 4A. The tooth pieces 172 (FIG. 4 A) and stator pieces 173 can be fabricated from low loss oriented grain electrical steel. In order to provide an efficient flux path between the tooth pieces through the outer ring 174 of the stator, intermediate transition pieces 175 (which can be made of non-oriented grain electrical steel) are provided to allow the flux to change direction efficiently.

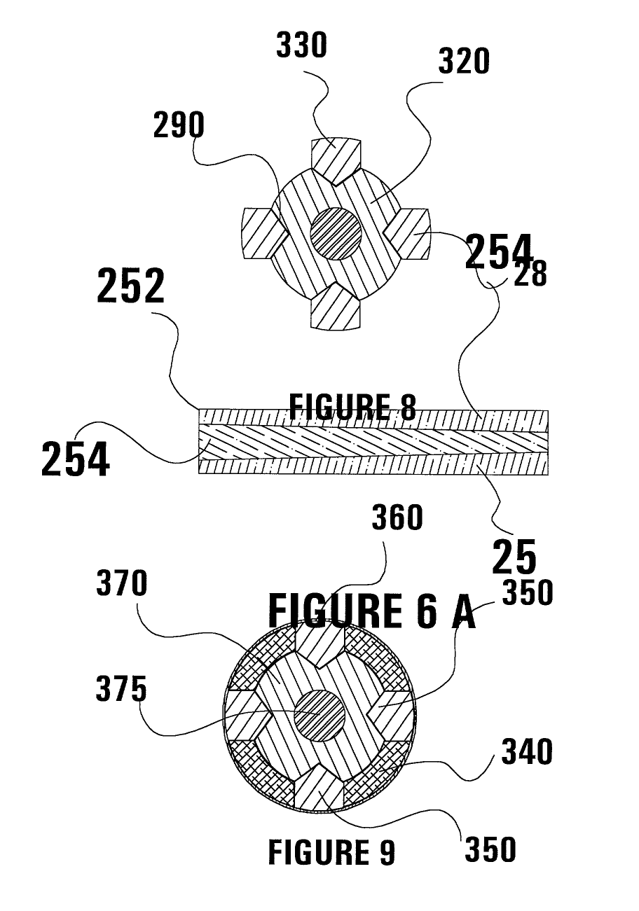

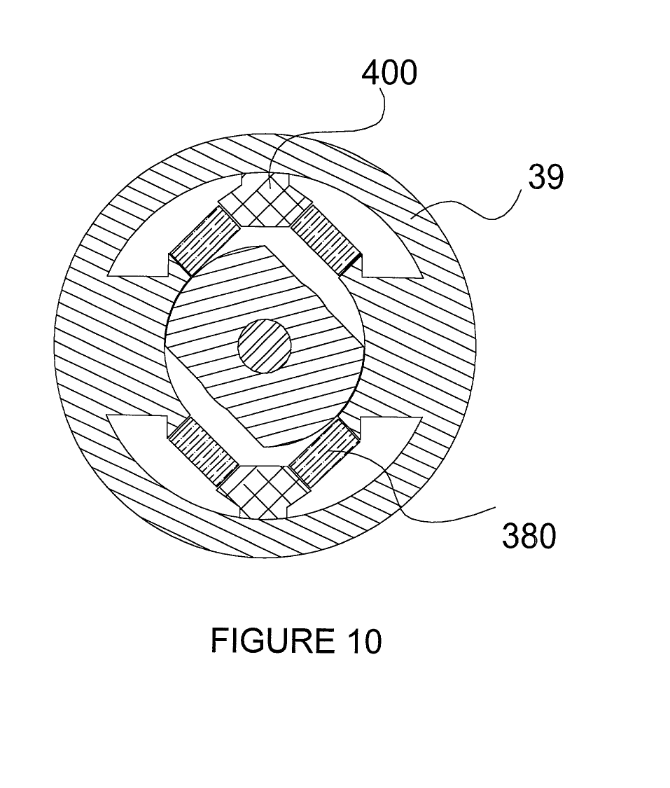

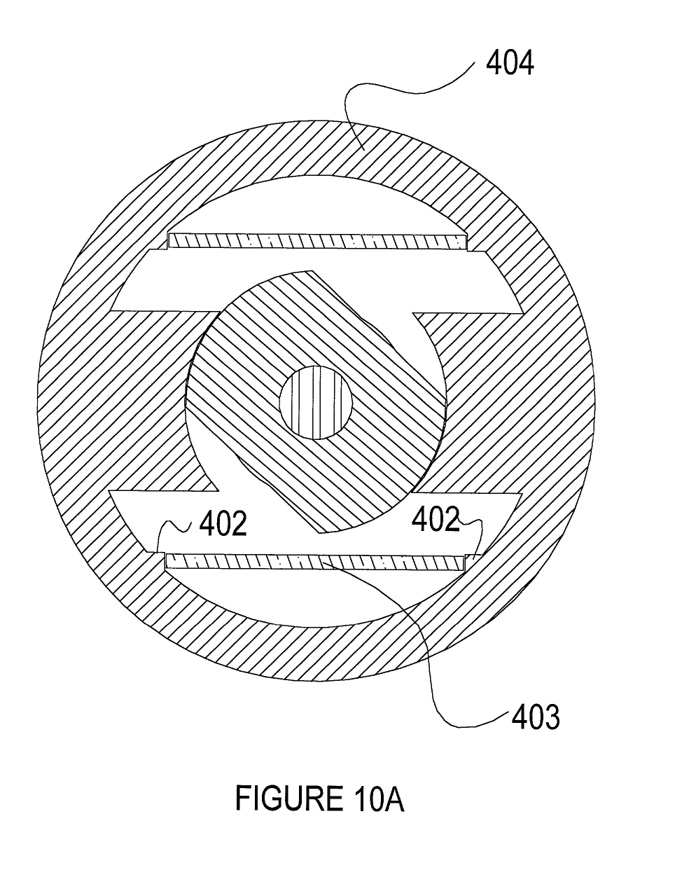

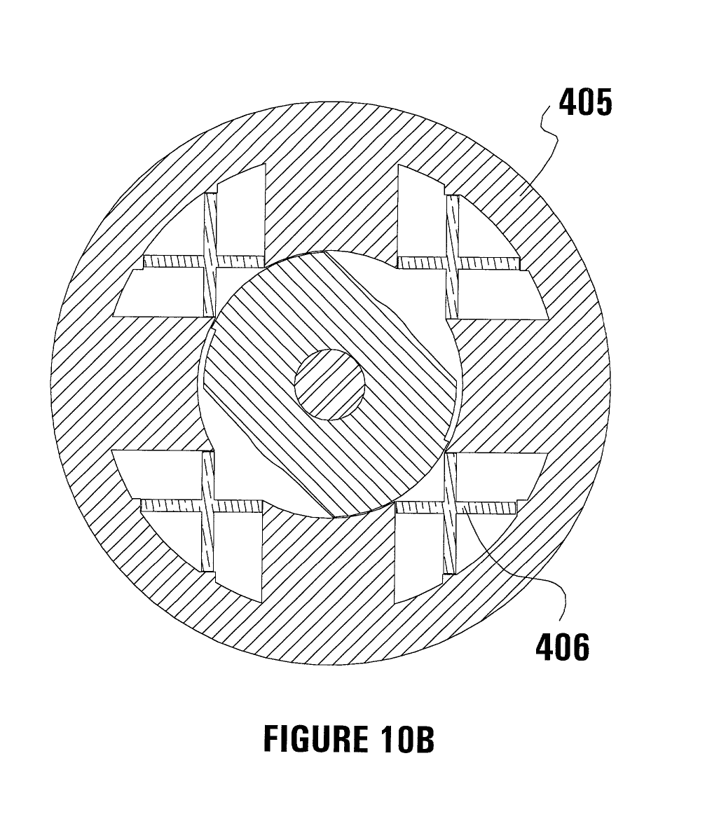

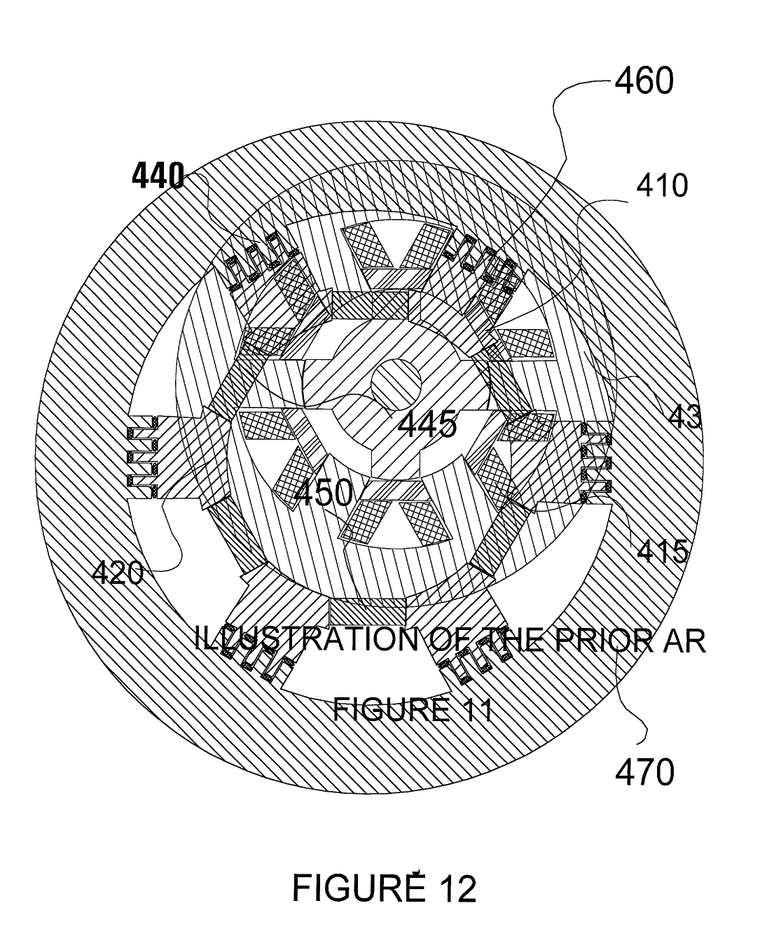

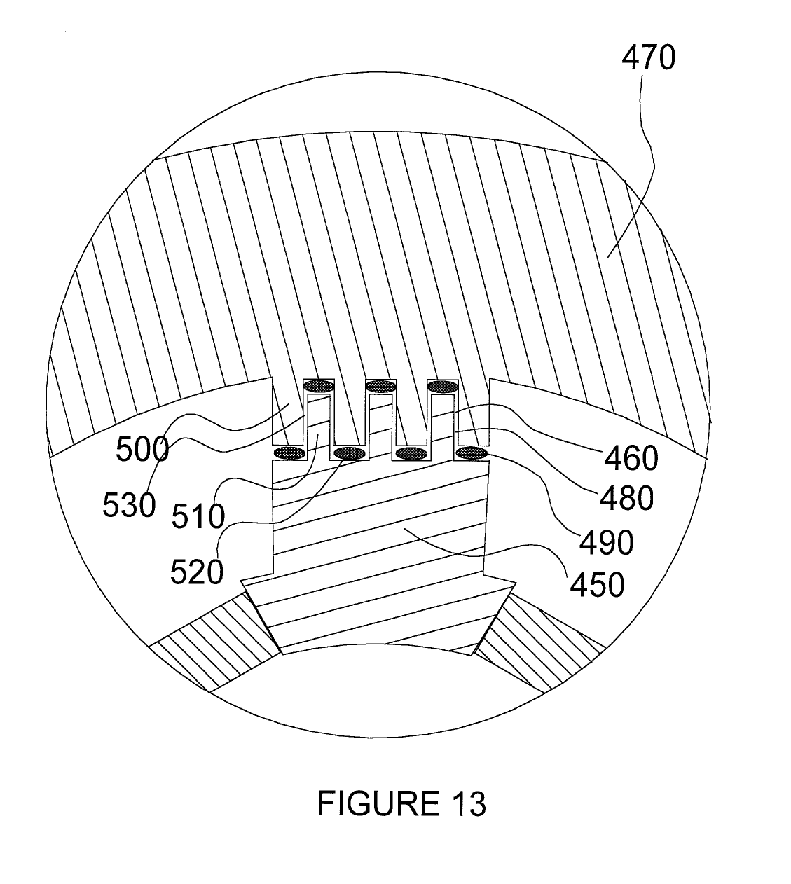

Significantly the improved slot wedges or spacers 190 (FIGS. 1, 3, 5, 6 and 7) which can be made of a ceramic material, laminated non-magnetic metal or other suitable material, are preferably non-magnetic, creep resistant, and have a high compressive strength. These spacers are installed between the tooth pieces 200 (FIG. 1) in a manner to create or facilitate a compressive force in a ring comprised of said spacers and the inner ends 210 of said tooth pieces 160. This compressive force is balanced, through the interaction of the tooth pieces, by an opposing tension in the outer ring 220 (FIG. 1) of the stator. The stator assembly is formed and assembled in a manner to provide opposing forces which are sufficient to cause the assembly of the spacers, tooth pieces (separate or integral) and the outer ring of the stator to assume much of the mechanical properties of one solid structure thus significantly reducing stator deflection and/or oscillations and the resultant acoustic noise. The springlike quality in the outer ring in the 10 sections 230 between the teeth can be minimized if these sections between the teeth are formed straight and without curvature. The above mentioned spacers contribute significantly to stiffen the stator assembly by modifying and/or moving each bending axis present in conventional stator designs. As an example if the stator teeth 82 (FIG. 4) were the active poles in the stator lamination 181, the bending axis would be near points 183 (without spacers). If spacers now are installed at between the teeth at positions 184, the bending axis splits and are now located near points 185.

Assembly can be facilitated by heating the outer ring of the stator while simultaneously cooling the spacers (and tooth pieces if they are separate) to create installation clearance by thermal expansion and contraction, and/or by mechanically and/or magnetically stretching the stator. Various jigs, fixtures, or cage like positioning devices can be formed to position the parts in order to facilitate this assembly process. If the aforementioned assembly processes cannot provide the magnitude of built in forces required to provide a stiff and stabile stator assembly, a high tensile strength sleeve 232 (FIG. 4A) can be provided and installed to supply or increase the stabilizing forces built into the stator assembly. This sleeve can be installed by heating to expand its inside diameter and quickly placing it over or around the stator assembly. As the sleeve cools, the inside diameter is reduced thus providing a compressing force to the outer ring of the stator thereby suppling or increasing the stabilizing forces in the stator assembly.

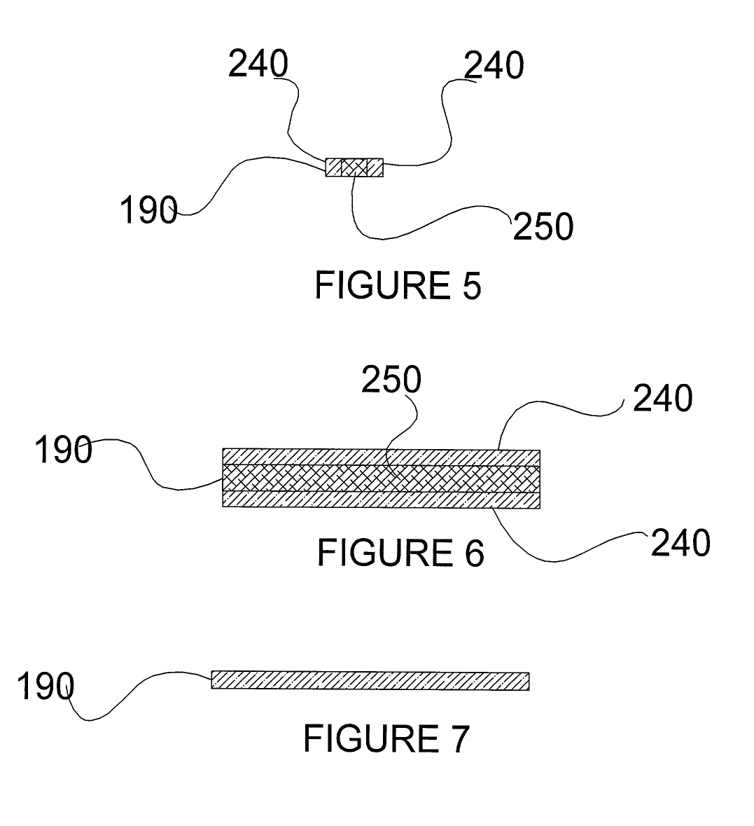

To address differing material thermal expansion issues during operation of the machine, the spacers 190 (FIG. 1, 3, 5, 6, and 7) can be made of two different materials to arrive at the correct total desired thermal expansion rate. An example of this would be to construct the ends 240 (FIG. 5 and 6) of the spacers (which contact the teeth) from a ceramic material, and, the middle 250 of the spacer (between the ceramic portions of the spacer) from aluminum. Many ceramics have a low coefficient of expansion and aluminum has a high coefficient of expansion. The length of each material in relation to each other could be adjusted to provide the correct total coefficient of expansion for the assembled two material spacer to provide relatively constant forces in the assembled stator even as the temperature of the machine rises and falls. Other materials and construction designs such as laminated non-magnetic metal spacers or fabricating each spacer 252 (FIG. 6A) from 2 or more somewhat triangular pieces 254 which can be forced together during installation to create the necessary forces to strengthen and stabilize the stator assembly are contemplated. The spacers can be modified to additionally reduce windage losses and/or hold and brace the windings firmly in place to reduce winding vibration. The aforementioned spacers and/or spacer construction aspects can be utilized in any slotted stator electric machine modified to accept them.

The machine has a rotor assembly 260 (FIG. 1, 2, and 3) and can include integral tooth pieces 270 (FIG. 1) or separate tooth pieces 280 (FIG. 8). The iron rotor laminations 290 (FIG. 1, 2, 3, and 8) can be coated and bonded together with a ceramic/porcelain enamel material 300 (FIG. 2 and 3) or other bonding agent between the laminations to stabilize, strengthen, and secure the rotor laminations and lamination assembly. The rotor lamination assembly can be formed of alternate layers of laminations 310 (FIG. 1) with integral tooth pieces 270, and, laminations 320 (FIG. 8) with separate tooth pieces 330. For higher efficiency, the rotor laminations with separate tooth pieces can be formed of non-oriented grain electrical steel and/or advantageously of low loss oriented grain electrical steel. The rotor and/or separate tooth pieces can be assembled from as many pieces and shapes of iron, formed powdered iron, magnets, amorphous steel and also oriented and non-oriented electrical steel as necessary to modify and improve the efficiency of the flux path therein.

The stator spacers can be modified to additionally provide a continuous surface inside the stator aperture in order to reduce high speed windage losses, and also allow and provide for the 10—stator to be used in a combined pump/motor scheme. The spacers can also have permanent magnets integral with their construction to provide excitation or a parking magnet arrangement.

The aforementioned separate tooth stator and rotor designs advantageously facilitate the fabrication of the stator and/or rotor from narrow strip lamination stock instead of wide sheet stock which is current practice thus reducing wasted material. The outer ring laminations of the stator can be formed from a strip rolled into a circle until the ends meet in a interlocking seam. The seams would be staggered and the assembly then could be bonded together to form a stator unit.

Rotor spacers 340 (FIG. 9) can be used to reduce high speed windage losses caused by the saliency of the rotor. The rotor which can have separate tooth pieces 350 and can include rotor spacers which can be secured together as an assembly by a thin high tensile strength sleeve 360. This sleeve would be installed in a manner to which would maintain a tension in the sleeve after installation in order to secure the rotor spacers and/or separate tooth pieces with a compressive force to the inner rotor laminations 370 and shaft 375.

The stator spacers 380 (FIG. 10) can be also used in a low tooth count stator such as a 2 tooth stator 390 through the use of non-magnetic and high compressive strength faux teeth 400. The aforementioned spacers and faux teeth can have permanent magnets integral with their construction. An alternative to the use of faux teeth in low tooth count stators is shown in FIG. 10A. The spacers 401 (FIG. 10A) are positioned between two points 402 in the outer ring 403 of the stator 404.

Some stator designs 405 (FIG. 10B) do not benefit from the stator spacers previously described and require a cross shaped spacer 406 (FIG. 10B) in order to modify the axis of bending and provide increased stiffness to the stator. Depending on a particular stator geometry, spacers in different shapes or combinations of shapes are sometimes necessary to move and/or modify the axis of bending in a manner to provide a stiffer stator construction and these are contemplated.

The prior wedges 410 (FIG. 11) used in the prior art are illustrated in FIG. 11. These prior wedges are formed usually of low compressive strength material and are utilized to create a small amount of force in order to secure the windings 415 in place, and, when required, formed to reduce windage losses. These prior wedges are of insufficient strength and are incorrect in geometric form to provide or facilitate the compressive force necessary to significantly strengthen the stator 420 and the stator assembly 430.

An additional noise control method contemplated and made possible by use of the spacers 445 (FIG. 12) is separate resilient mounted stator teeth 450 (FIG. 12 and 13). A modified intersection 460 between the stator teeth and the outer ring of the stator 470 can be used to reduce the magnetic force developed (perpendicular to the individual stator teeth) between the stator teeth and the outer ring of the stator during the operation of the machine. The intersection can have a saw tooth, sinusoidal or preferably a square wave shape 480 (FIG. 13) and include resilient cushions 490 in the root to provide mechanical isolation between the teeth and the outer ring of the stator thereby significantly reducing noise emitted by the stator ring. The effectiveness of the intersection 460 in reducing the force developed between the stator teeth and the outer ring of the stator while minimizing flux losses incurred across the intersection are affected by the distance between the intersection teeth 500 and 510. The spaces 520 where the resilient cushion 490 resides is preferably larger than the spaces 530 between the intersection teeth. It is preferable to make the spaces 530 as small as practical. This arrangement causes a significant reduction in the magnetic forces (perpendicular to the individual stator teeth) developed between the stator teeth and the outer ring of the stator during operation of the machine by modifying the direction of the magnetic forces thereby additionally isolating the teeth from the outer ring of the stator. The width of the stator tooth at the intersection and the intersection can be made wider to minimize flux losses across the intersection.

What is claimed is:

1. An electric machine comprising:
a stator having a plurality of teeth directed inwardly;
a plurality of spacers located between said teeth, said spacers sized to bias said teeth outwardly; and
said teeth and said spacers form a chamber in which a rotor is located.
